(19) United States
(12) Patent Application Publication
(10) Pub. No.: US 2024/0343217 A1
(43) Pub. Date: Oct. 17, 2024

(54) ENERGY-EFFICIENT COLLISION DETECTION AND MOTION PLANNING

(71) Applicant: The University of British Columbia, Vancouver (CA)

(72) Inventors: Tor M. AAMODT, Vancouver (CA); Deval Ashokbhai SHAH, Vancouver (CA); Ningfeng YANG, Vancouver (CA)

(21) Appl. No.: 18/633,439

(22) Filed: Apr. 11, 2024

Related U.S. Application Data
(60) Provisional application No. 63/458,535, filed on Apr. 11, 2023.

(51) Int. Cl. B60R 21/013

(52) U.S. Cl. CPC B60R 21/013

(57) ABSTRACT

Systems and methods for evaluating whether there is a collision between a first object represented by a first bounding volume and a second object represented by a second bounding volume, the method comprising determining at least one internal shape contained within the first bounding volume, and determining that there is an intersection between the at least one internal shape and the second bounding volume to conclude that there is a collision between the first object and the second object. Other aspects relate to systems and methods for filtering a plurality of candidate poses between first second objects.

### CROSS-REFERENCE TO RELATED APPLICATIONS

This application claims priority from U.S. application No. 63/458,535 filed 11 Apr. 2023 and entitled ENERGY-EFFICIENT REALTIME MOTION PLANNING which is hereby incorporated herein by reference for all purposes. For purposes of the United States of America, this application claims the benefit under 35 U.S.C. § 119 of U.S. application No. 63/458,535 filed 11 Apr. 2023 and entitled ENERGY-EFFICIENT REALTIME MOTION PLANNING.

### FIELD

This invention relates to motion planning and, in particular, collision detection in motion planning. Aspects of the invention relate to intersection tests between bounding volumes that represent objects.

### BACKGROUND

Motion planning, and in particular, real-time motion planning for safe navigation through a dynamic environment is a fundamental problem in a wide variety of technological applications, including, but not limited to, autonomous robotics, self-driving vehicles, virtual reality devices, augmented reality devices, etc.

An aspect of the problem of motion planning relates to collision detection (e.g. detection of a potential collision between a robot and an environmental obstacle). Collision detection in motion planning is a computational process used to determine if one or more objects occupy the same space at the same time or if their paths will intersect at any point in the future. Collision detection tests are used to plan a collision-free movement trajectory.

One example non-limiting application of motion planning and collision detection is autonomous robotics, where an autonomous robot is tasked to navigate an environment. FIG. 1A is a schematic diagram illustrating an example motion trajectory 10 of a robotic arm 12 relative to an obstacle 14 in physical space. FIG. 1B is a plot 20 showing the trajectory of the movement of robotic arm 12 in a configuration space (referred to herein as a “C-space”).

FIG. 1A illustrates a robot arm 12 moving through a trajectory 10 in physical space. Seven distinct poses 12-1 to 12-7 of robot arm 12 are shown in the schematic illustration of FIG. 1A. Each of poses 12-1 to 12-7 is a position that robot arm 12 would occupy over the course of traversing trajectory 10. An obstacle 14 is shown occupying a position within the physical space. As shown in FIG. 1A, poses 12-3, 12-4 and 12-5 intersect with obstacle 14 in the physical space if trajectory 10 were to be followed by robot arm 12.

Plot 20 shows the trajectory followed by robot arm 12 in FIG. 1A in a C-space defined by a plurality of C-space parameters (e.g. first and second C-space parameters in the case of the 2-dimensional FIG. 1B example). The C-space parameters are shown illustratively as the axes of the FIG. 1B plot 20. In general, C-space parameters may be any suitable parameters that define and/or span the C-space. C-space points 22-1 to 22-7 shown in plot 20 of FIG. 1B correspond to poses 12-1 to 12-7 shown in FIG. 1A. C-space points 22-3 to 22-5 are shown in black fill to indicate a collision between robot arm 12 and obstacle 14 in poses 12-3 to 12-5.

Collision detection may be performed to determine if a first object (e.g. a robot arm) collides with a second object (e.g. an object in an environment) for any given position in a planned trajectory. One known approach to collision detection is performing an intersection test between two primitive shapes. For the intersection test, a first volume is chosen to bound (i.e. contain) the first object and a second volume is chosen to bound (i.e. contain) the second object, such that the first and second bounding volumes respectively contain the first and second objects.

The first and second bounding volumes are typically chosen from primitive shapes for simplicity and efficiency. For example, cuboid bounding boxes are often chosen for their simplicity and/or efficiency. Bounding boxes can be characterized as oriented bounding boxes (OBB) or axis-aligned bounding boxes (AABB). AABBs are bounding boxes that have their edges aligned with (e.g. parallel to) the axes of the coordinate system used to define the physical space. OBBs are bounding boxes having edges with arbitrary orientations that do not necessarily align with any axes of the coordinate system used to define the physical space. AABBs are typically simpler and faster to test for intersections (due to their alignment with the axes of the coordinate system), but may not fit (or represent) the object as closely as OBBs. OBBs may provide a closer fit or representation of physical objects and more accurate collision detection, typically at the cost of more complex intersection tests.

One known type of intersection test is the separating axis test, which can be used to perform an intersection test between any two convex shapes or volumes. The rationale of a separating axis test is that two convex shapes or volumes do not intersect if there exists an axis (axis normal to a separating line in 2-dimensional (2D) space or to a separating plane in 3-dimensional (3D) space, respectively) such that the projections of the shapes or volumes onto that axis do not intersect.

FIG. 1C is a schematic diagram 30 illustrating an example separating axis test between two 2D shapes 32 and 34. In FIG. 1C, shapes 32 and 34 are both 2D rectangles which may represent bounding boxes.

In FIG. 1C, separating axis 31 meets the requirement of the separating axis test because projection 32P of shape 32 and projection 34P of shape 34 onto separating axis 31 do not intersect. A separating line 33 orthogonal to separating axis 31 may be drawn to separate shapes 32 and 34. For 3D objects, the separating line between objects would be a separating plane and the separating axis onto which objects are projected would be an axis normal to the separating plane.

To determine whether two shapes or volumes (e.g. cuboid bounding boxes) intersect in accordance with the separating axis test, one must determine whether any separating axis (line or plane) exists. If a separating axis (line or plane) exists, then the two shapes do not intersect; otherwise, the two shapes intersect. For a pair of 2D rectangular objects, there are 4 candidate separating axes to evaluate. For a pair of 3D cuboid objects, however, there are 15 candidate separating axes to evaluate. The increase in computational burden for 3D objects relative to 2D objects is significant. For example, for a 2D pair of OBB-AABBs, the number of multiplications required to evaluate all 4 possible candidate separating axes is 12. In comparison, for a 3D pair of OBB-AABBs, the number of multiplications required to evaluate all 15 possible candidate separating axes is 81.

In certain applications, such as in the fields of robots and/or automated vehicles, the robots/vehicles need to react to moving objects in their environment. There is a corresponding desire to accomplish motion planning within desired real-time constraints and/or using a desirably low amount of computational resources. Further, energy efficiency of motion planning is also important. Efficient use of energy can increase the operation time of mobile robots, for example.

For some applications, there is a desire to lower a runtime and/or energy of motion planning (i.e. collision tests) as much as possible. For example, separating axis tests can be performed in parallel to accelerate (reduce the runtime and energy) associated with collision testing. FIG. 1D is a bar chart 40 showing approximate runtime and number of multiplication operations (a proxy for energy) used for sequential execution and parallel execution of separating axis tests for collision-free cases. As can be seen from FIG. 1D, while parallel execution reduces runtime by about half compared to sequential execution, parallel execution results in approximately three times increase in energy consumption for collision-free cases.

Motion planning is a computationally intensive task with computational demand increasing rapidly with an increasing number of degrees of freedom (DOF) of a motion planning object (e.g. a robot, autonomous vehicle and/or the like). Typically, more than 90% of computation time in motion planning is spent on collision detection. It has also been estimated that real-time motion planning can contribute to 15% to 50% of total power consumption in a robot.

One example application of collision detection is in robots with relatively high DOFs (e.g. a 7-DOF robot). High-DOF robots can perform more than one task and/or complex tasks in cluttered environments, thus providing more functionalities. However, the latency of motion planning for high-DOF robots is still undesirably high and currently a major impediment to their deployment.

There is a general desire for improving the performance (e.g. timing, use of computational resources and/or the like) of motion planning, including collision detection, relative to prior art techniques. There is also a desire to limit or reduce energy consumption associated with motion planning, including collision detection, relative to prior art techniques.

### SUMMARY

One aspect of the invention provides a method for evaluating whether there is a collision between a first object represented by a first bounding volume and a second object represented by a second bounding volume. The method comprises: determining at least one internal shape, the at least one internal shape contained within the first bounding volume; and, determining that there is an intersection between the at least one internal shape and the second bounding volume to conclude that there is a collision between the first object and the second object.

The method may comprise: determining a bounding shape, wherein the bounding shape contains the first bounding volume; and determining that there is no intersection between the bounding shape and the second bounding volume to conclude that there is no collision between the first object and the second object.

The method may comprise determining that there is no intersection between the at least one internal shape and the second bounding volume and thereby concluding that further collision testing is required to evaluate whether there is a collision between the first object and the second object.

The method may comprise, after concluding that further collision testing is required, performing the further collision testing to evaluate whether there is a collision between the first object and the second object.

The method may comprise determining that there is no intersection between the at least one internal shape and the second bounding volume and that there is an intersection between the bounding shape and the second bounding volume and thereby concluding that further collision testing is required to evaluate whether there is a collision between the first object and the second object.

The method may comprise, after concluding that further collision testing is required, performing the further collision testing to evaluate whether there is a collision between the first object and the second object.

Determining that there is an intersection between the at least one internal shape and the second bounding volume and determining that there is no intersection between the bounding shape and the second bounding volume may be performed using a parallel processing technique.

The at least one internal shape may comprise an inscribed shape. The at least one internal shape may comprise the largest sphere that is contained within the first bounding volume.

The first bounding volume may be inscribed within the bounding shape. The bounding shape may comprise the smallest sphere that encloses the first bounding volume.

The at least one internal shape may be parameterized by a number n of parameters that is fewer than a number m of parameters used to parameterize the first bounding volume. The number m of parameters used to parameterize the first bounding volume may be 9. The number n of parameters used to parameterize the internal shape may be 4.

The bounding shape may be parameterized by a number p of parameters that is fewer than a number m of parameters used to parameterize the first bounding volume. The number p of parameters used to parameterize the bounding shape may be 4.

The first bounding volume may comprise an oriented bounding box (OBB). The second volume may comprise one of: an OBB and an axis-aligned bounding box (AABB).

Determining that there is an intersection between the at least one internal shape and the second bounding volume may require computing no more than three multiplications.

Determining that there is no intersection between the bounding shape and the second bounding volume may require computing no more than three multiplications.

The at least one internal shape may comprise two or more internal shapes. Determining that there is an intersection between the at least one internal shape and the second bounding volume may comprise determining that there is an intersection between the second bounding volume and at least one of the two or more internal shapes.

Another aspect of the invention provides a method for filtering a plurality of candidate poses between a first object and a second object in a collision detection test between the first object represented by a first bounding volume and the second object represented by a second bounding volume. The method comprises: determining at least one internal shape, the at least one internal shape contained within the first bounding volume; and eliminating one or more colliding poses from the plurality of candidate poses by, for each colliding pose, determining that there is an intersection between the at least one internal shape and the second bounding volume to conclude that there is a collision between the first object and the second object.

The method may comprise: determining a bounding shape, wherein the bounding shape contains the first bounding volume; and eliminating one or more non-colliding poses from the plurality of candidate poses by, for each non-colliding pose, determining that there is no intersection between the bounding shape and the second bounding volume to conclude that there is no collision between the first object and the second object.

The method may comprise performing further collision testing for non-eliminated candidate poses.

The plurality of candidate poses may comprise a plurality of poses in a proposed motion trajectory or a plurality of randomly generated poses for at least one of the first and second objects.

Another aspect of the invention provides a system comprising a processor configured to perform any of the methods described herein.

It is emphasized that the invention relates to all combinations of the above features, even if these are recited in different claims.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1A is schematic diagram illustrating an example motion trajectory of a robotic arm relative to an obstacle in physical space.

FIG. 1B is an example plot showing the FIG. 1A trajectory in a configuration space (referred to herein as a “C-space”).

FIG. 1C is a schematic diagram illustrating an example separating axis test between two 2D shapes.

FIG. 1D is a bar chart comparing runtime and energy consumption between sequential processing and parallel processing of example separating axis tests.

FIG. 2A is a flowchart of a method for evaluating whether there is a collision (performing a collision test) between a first object and a second object according to an example embodiment.

FIG. 2B is a schematic diagram showing a cross-sectional view of an internal shape intersection test according to an example embodiment.

FIG. 2C is a schematic diagram showing a cross-sectional view of an internal shape intersection test according to another example embodiment.

FIG. 2D is a schematic diagram showing a cross-sectional view of an internal shape intersection test according to another example embodiment.

FIG. 2E is a schematic diagram showing a cross-sectional view of an internal shape intersection test with two internal shapes according to an example embodiment.

FIG. 2F is a schematic diagram showing a cross-sectional view of an internal shape intersection test with three internal shapes according to an example embodiment.

FIG. 2G is a schematic diagram showing a cross-sectional view of an internal shape intersection test with an internal shape for each bounding volume according to an example embodiment.

FIG. 3A is a flowchart of a method for evaluating whether there is a collision (performing a collision test) between a first object and a second object according to another example embodiment.

FIG. 3B is a schematic diagram showing a cross-sectional view of a bounding shape intersection test according to an example embodiment.

FIG. 3C is a schematic diagram showing a cross-sectional view of a bounding shape intersection test according to another example embodiment.

FIG. 3D is a schematic diagram showing a cross-sectional view of a bounding shape intersection test according to another example embodiment.

FIG. 4 is a flowchart of a method for evaluating whether there is a collision (performing a collision test) between a first object and a second object according to another example embodiment.

FIG. 5A is a flowchart of a method for filtering a plurality of candidate poses between a first object and a second object according to an example embodiment.

FIG. 5B is a flowchart showing a logical flow of a method for detecting collisions in poses of a motion trajectory according to an example embodiment.

FIG. 6 depicts an exemplary system for performing one or more methods described herein (e.g. the methods of FIGS. 2A, 3A, 4, 5A and 5B) according to an example embodiment.

FIG. 7A is a bar chart showing the efficacy of internal shape intersection test and bounding shape intersection test from experimental data . . .

FIG. 7B is a plot showing the cost of different configurations of internal shape intersection tests versus the fraction of colliding cases filtered by these different configurations of internal shape intersection tests from experimental data.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Aspects of the invention provide methods for evaluating whether there is collision between a first object and a second object respectively represented by first and second bounding volumes. Methods described herein determine suitable internal shape(s) internal to corresponding bounding volume(s) and/or bounding shape(s) that contain corresponding bounding volume(s); and perform respective internal shape intersection tests and/or bounding shape intersection tests to evaluate whether the first bounding volume intersects the second bounding volume. In an internal shape intersection test, if the internal shape(s) internal to the first bounding volume intersect with the second bounding volume, then it can be concluded that the first and second bounding volumes intersect, and therefore there is a collision between the first and second objects. In a bounding shape intersection test, if the bounding shape that contains the first bounding volume does not intersect with the second bounding volume, then it can be concluded that the first and second bounding volumes do not intersect, and therefore there is no collision between the first and second objects. In some embodiments or applications, the second bounding volume used in the bounding shape intersection test may itself be a bounding shape.

Other aspects of the invention provide methods for applying the internal shape intersection test and/or the bounding shape intersection test to collision detection in motion trajectory planning. The application of the internal shape intersection test and/or the bounding shape intersection test to collision detection may advantageously reduce computational expense of trajectory planning and/or collision detection compared to known intersection tests, such as the separating axis test, by using less computation to reach a conclusion on whether there is intersection or no intersection between the bounding volumes for at least some of the poses in a planned trajectory.

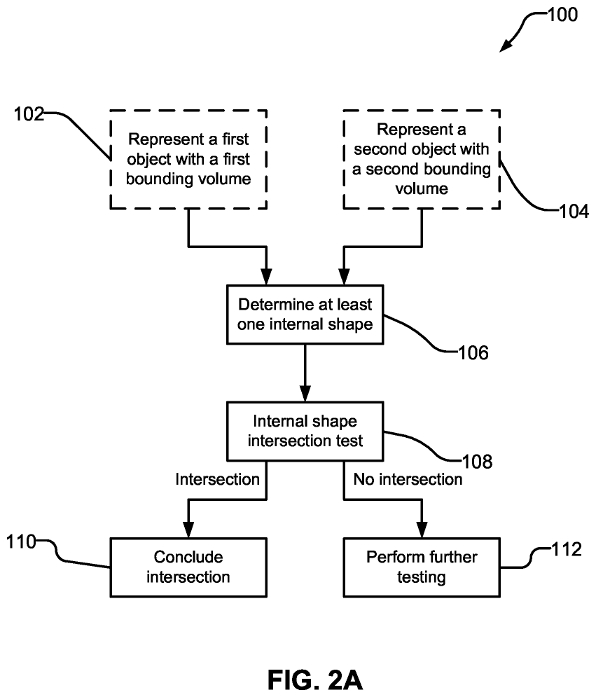

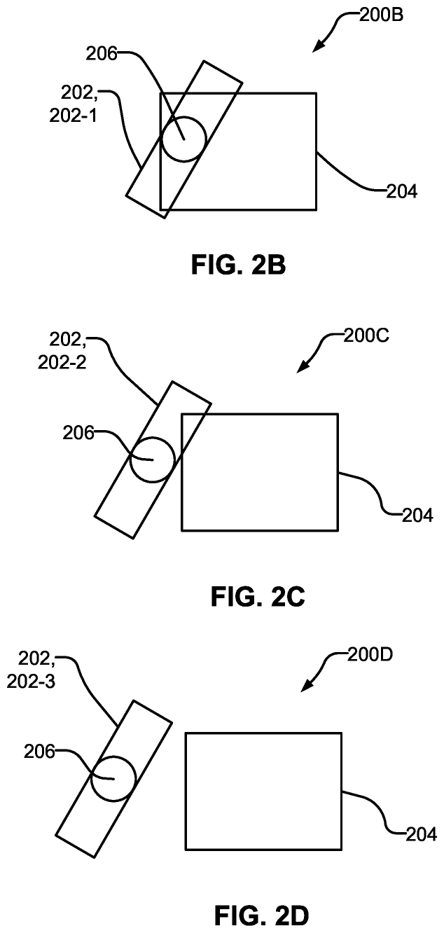

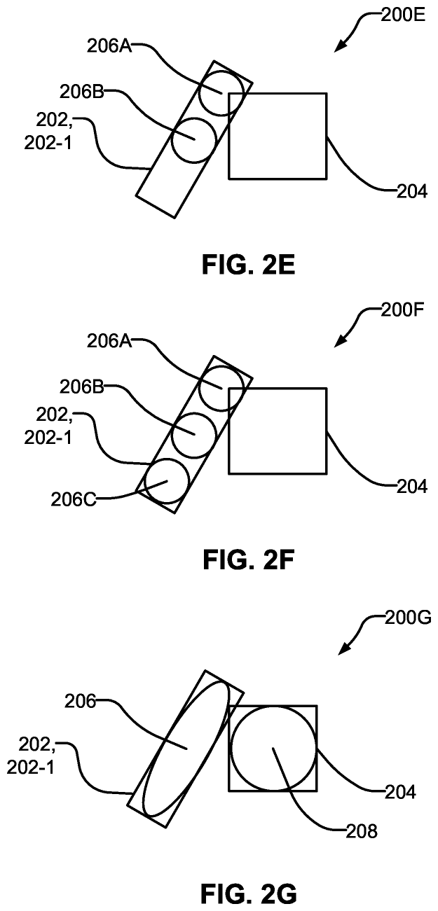

FIG. 2A is a flowchart for a method 100 of evaluating whether there is a collision between a first object and a second object according to an example embodiment.

Method 100 begins with optional steps 102 and 104 of representing a first object with a first bounding volume and representing a second object with a second bounding volume. The first bounding volume contains the first object and the second bounding volume contains the second object.

In a non-limiting example embodiment, the first object may be a robotic arm, autonomous vehicle and/or the like represented by a first bounding volume (e.g. an OBB) and the second object may be an environmental obstacle represented by a second bounding volume (e.g. an AABB). In some embodiments, the second object is also represented by an OBB.

In some embodiments, the first and second objects are already represented respectively by first and second bounding volumes prior to method 100. In such embodiments, method 100 may receive the first and second objects (e.g. as input), skip steps 102 and 104 and start with step 106.

Method 100 then proceeds to step 106 which determines at least one internal shape (referred to as the “internal shape” herein for conciseness). The internal shape is determined for at least one of the first and second bounding volumes. In some embodiments, two or more internal shapes are determined for a bounding volume. In some embodiments, at least one first internal shape is determined for the first bounding volume and at least one second internal shape is determined for the second bounding volume.

The internal shape is chosen such that the internal shape is contained (i.e. wholly enclosed) within the corresponding bounding volume. The internal shape may be positioned at any suitable position within the bounding volume. In some embodiments, a center of the internal shape is located at the same location as a center of the bounding volume. In some embodiments, a center of the internal shape is located at a different location from the center of the bounding volume.

The internal shape(s) determined in step 106 may be any suitable shape(s). In some embodiments, the internal shape is an inscribed shape. In some embodiments, the internal shape comprises a circle (for 2D applications) or a sphere (for 3D applications). In some embodiments, the internal shape corresponding to a particular bounding volume is a sphere that is as large as possible and is contained within the bounding volume. In some embodiments, the internal shape corresponding to a particular bounding volume is a sphere that is as large as possible and is contained within the bounding volume and has a center that is located at a center of the bounding volume.

In some embodiments, the internal shape is parameterized by a number n of parameters that is fewer than a number m of parameters used to parameterize the bounding volume. In some embodiments, the number m of parameters used to parameterize the bounding volume is 9. For example, an oriented cuboid bounding box as the bounding volume is parameterized by 9 parameters: 3 parameters for a coordinate of a vertex in 3D space, 3 parameters for lengths of each of the cuboid's unique edges, and 3 rotational parameters. In some embodiments, the number n of parameters used to parameterize the internal shape is 4. For example, a sphere as the internal shape is parameterized by 4 parameters: 3 parameters for a coordinate of the center of the sphere in 3D space and 1 parameter for a radius r of the sphere. Performing an intersection test between an internal shape parameterized by fewer parameters than a first bounding volume and a second bounding volume may involve using less computational resources when compared to performing an intersection test between the two bounding volumes. For example, using the separating axis tests to perform an intersection test between a first OBB bounding volume and a second AABB bounding volume may require up to 81 multiplications to check all 15 possible separating axes between the OBB and AABB. In contrast, performing an intersection test for a spherical internal shape internal to the first OBB bounding volume and the second AABB bounding volume involves only 3 multiplications.

After determining the internal shape in step 106, method 100 proceeds to step 108 which performs an internal shape intersection test for the pair of first and second bounding volumes. The internal shape intersection test checks whether the step 106 internal shape (which is internal to one of the bounding volumes) intersects with the other bounding volume.

FIG. 2B is a schematic diagram showing a cross-sectional view of an internal shape intersection test 200B according to a non-limiting example embodiment.

In FIG. 2B, first bounding volume 202 is shown in a pose 202-1. An internal shape 206 has been chosen for first bounding volume 202 such that internal shape 206 is contained within first bounding volume 202. In FIG. 2B, internal shape 206 is shown as a sphere for illustrative purposes only. Internal shape 206 may be any suitable shape. For example, internal shape 206 may be ellipsoidal in shape.

In FIG. 2B, internal shape 206 intersects second bounding volume 204 when first bounding volume 202 is in pose 202-1. The intersection between internal shape 206 and second bounding volume 204 leads to the conclusion that there is an intersection between first and second bounding volumes 202, 204 because internal shape 206 is completely contained within bounding volume 202, so it would be impossible for internal shape 206 and second bounding volume 204 to intersect without first and second bounding volumes 202, 204 also intersecting.

Returning to FIG. 2A, if it is determined at step 108 that there is an intersection between the internal shape (e.g. internal shape 206) and the other bounding volume (e.g. second bounding volume 204), then method 100 proceeds to step 110 which concludes that there is a collision between the first and second objects (which are respectively represented by the first and second bounding volumes (e.g. first and second bounding volumes 202, 204)).

On the other hand, if there is no intersection between the internal shape (e.g. internal shape 206) and the second bounding volume (e.g. second bounding volume 204) at step 108, then it is inconclusive whether the first and second objects would collide. FIG. 2C is a schematic diagram showing a cross-sectional view of an internal shape intersection test 200C according to another non-limiting example embodiment. FIG. 2D is a schematic diagram showing a cross-sectional view of an internal shape intersection test 200D according to another non-limiting example embodiment. In FIGS. 2C and 2D, internal shape 206 is shown as a sphere, but this is not necessary and internal shape 206 may be any suitable shape.

In FIG. 2C, first bounding volume 202 is in a pose 202-2. Internal shape 206 does not intersect second bounding volume 204 in intersection test 200C. However, as can be seen from FIG. 2C, first bounding volume 202 nonetheless intersects second bounding volume 204. In FIG. 2D, first bounding volume 202 is in a pose 202-3. Internal shape 206 does not intersect second bounding volume 204 in intersection test 200D. First bounding volume 202 also does not intersect second bounding volume 204 in pose 202-3. FIGS. 2C and 2D illustrate that if there is no intersection between internal shape 206 and second bounding volume 204 in the block 106 internal shape intersection test, then it is not possible to draw definitive conclusions about collisions between first and second bounding volumes 202, 204.

Therefore, returning to FIG. 2A, if there is no intersection between the internal shape (e.g. internal shape 206) and the other bounding volume (e.g. second bounding volume 204), method 100 proceeds to step 112 to perform further collision testing because the block 106 internal shape intersection test is inconclusive.

Different variations of the block 106 internal shape intersection test can be applied in method 100. FIG. 2E is a schematic diagram showing a cross-sectional view of an internal shape intersection test 200E with two internal shapes 206A, 206B according to an example embodiment. FIG. 2F is a schematic diagram showing a cross-sectional view of an internal shape intersection test 200F with three internal shapes 206A, 206B, 206C according to another example embodiment. FIG. 2G is a schematic diagram showing a cross-sectional view of an internal shape intersection test 200G with a respective internal shape 206, 208 for each of the first and second bounding volumes 202, 204 according to another example embodiment. The internal shapes shown in FIGS. 2E-G are for illustrative purposes only and are non-limiting example embodiments.

In FIG. 2E, internal shape intersection test 200E shows a first bounding volume 202 in a pose 202-1 with two internal shapes 206A, 206B. Internal shape intersection test 200E determines whether second bounding volume 204 intersects with at least one of internal shapes 206A, 206B. If second bounding volume 204 intersects at least one of internal shapes 206A, 206B, then it can be concluded that first bounding volume 202 intersects second bounding volume 204. Compared to an internal shape intersection test with only one internal shape 206 (e.g. as shown in FIGS. 2B-2D), internal shape intersection test 200E may increase the odds of the block 106 internal shape intersection test identifying an intersection between the first and second bounding volumes 202, 204 at the expense of a possibly increased number computational steps. If there is no intersection between bounding volume 204 and either of internal shapes 206A, 206B in internal shape intersection test 200E (FIG. 2E), then internal shape intersection test 200E is inconclusive as to whether there is an intersection between bounding volumes 202, 204. Internal intersection tests between internal shapes 206A, 206B and second bounding volume 204 may be performed in parallel or sequentially in any suitable order.

In FIG. 2F, internal shape intersection test 200F shows a first bounding volume 202 in a pose 202-1 with three internal shapes 206A, 206B and 206C. Internal shape intersection test 200F determines whether second bounding volume 204 intersects at least one of internal shapes 206A, 206B, 206C. If second bounding volume 204 intersects at least one of internal shapes 206A, 206B, 206C, then it can be concluded that first bounding volume 202 intersects second bounding volume 204. Compared to an internal shape intersection test with fewer number of internal shapes (e.g. the single internal shape embodiment of FIGS. 2B-2D and the two internal shape embodiment of FIG. 2E), internal shape intersection test 200F may increase the odds of the block 106 internal shape intersection test identifying an intersection between the first and second bounding volumes 202, 204 at the expense of a possibly increased number of computational steps. If there is no intersection between bounding volume 204 and any of internal shapes 206A, 206B and 206C in internal shape intersection test 200F (FIG. 2F), then internal shape intersection test 200F is inconclusive as to whether there is an intersection between bounding volumes 202, 204. Internal intersection tests between internal shapes 206A, 206B, 206C and second bounding volume 204 may be performed in parallel or sequentially in any suitable order.

In FIG. 2G, internal shape intersection test 200G shows a first bounding volume 202 in a pose 202-1 with an internal shape 206. In FIG. 2G, internal shape 206 comprises a substantially elliptical shaped volume which occupies a greater portion of the interior volume of first bounding volume 202 than a sphere would. Compared to choosing an internal shape that occupies a smaller portion of the interior volume of first bounding volume 202 (e.g. the spherical shape of FIGS. 2B-2D), choosing an internal shape that occupies a larger portion of interior volume of first bounding volume 202 may increase the odds of the block 106 internal shape intersection test identifying an intersection between the internal shape and the second bounding volume 204 at the expense of possibly increasing the complexity (e.g. the number of parameters needed to define the internal shape) of the computation. If there is no intersection between bounding volume 204 and internal shape 206 in internal shape intersection test 200G (FIG. 2G), then internal shape intersection test 200G is inconclusive as to whether there is an intersection between bounding volumes 202, 204.

FIG. 2G also displays another embodiment where, a second internal shape 208 is determined for second bounding volume 204. Internal shape intersection test 200G may determine whether first internal shape 206 and second internal shape 208 intersect. If first internal shape 206 and second internal shape 208 intersect, then it can be concluded that the first and second bounding volumes 202 and 204 also intersect. In some embodiments, second internal shape 208 is parameterized by fewer number of parameters than second bounding volume 204. If there is no intersection between internal shapes 206, 208 in internal shape intersection test 200G (FIG. 2G), then internal shape intersection test 200G is inconclusive as to whether there is an intersection between bounding volumes 202, 204. Compared to other internal shape intersection tests, internal shape intersection test 200G may reduce the number of parameters required to define each of the two shapes used for internal shape intersection test (e.g. second internal shape 208 vs. second bounding volume 204; internal shape 206 vs. first bounding volume 202) at the expense of possibly increasing the likelihood of inconclusive results.

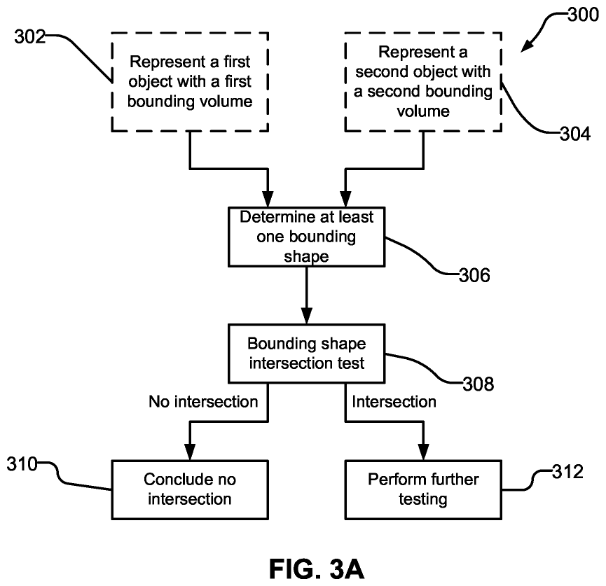

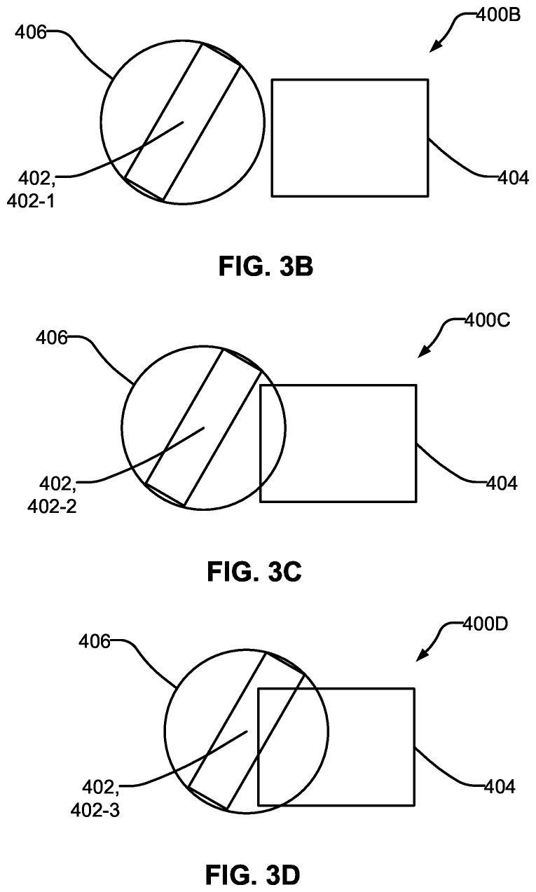

FIG. 3A is a flowchart for a method 300 of evaluating whether there is a collision between a first object and a second object according to another example embodiment.

Similar to method 100, method 300 begins with the optional steps 302 and 304 of representing a first object with a first bounding volume and representing a second object with a second bounding volume. The first and second bounding volumes respectively contain the first and second objects. The description of steps 102, 104 of method 100 similarly applies to steps 302, 304 of method 300 and for the sake of brevity will not be repeated here.

Method 300 then proceeds to step 306 which determines a bounding shape for at least one of the first and second bounding volumes. The step 306 bounding shape is chosen such that the bounding shape contains (i.e. completely encloses) its corresponding bounding volume. The bounding shape may contain the bounding volume in any suitable manner. In some embodiments, a center of the bounding shape is located at the same location as a center of its corresponding bounding volume. In some embodiments, a center of the bounding shape is located at a different location from the center of its corresponding bounding volume.

In some embodiments, the bounding volume is inscribed within the bounding shape. In some embodiments, the bounding shape comprises a circle (for 2D applications) or a sphere (for 3D applications). In some embodiments, the bounding shape is the smallest sphere that contains its corresponding bounding volume. In some embodiments, the bounding shape is the smallest sphere that contains its corresponding volume and has a center that is located at the center of the corresponding bounding volume.

In some embodiments, the bounding shape is parameterized by a number p of parameters that is fewer than a number m of parameters used to parameterize the first bounding volume. In some embodiments, the number m of parameters used to parameterize the first bounding volume is 9. For example, an oriented cuboid bounding box as the bounding volume is parameterized by 9 parameters: 3 parameters for a coordinate of a vertex in 3D space, 3 parameters for lengths of each of the cuboid's unique edges, and 3 rotational parameters. In some embodiments, the number p of parameters used to parameterize the bounding shape is 4. For example, a sphere as the bounding shape is parameterized by 4 parameters: 3 parameters for a coordinate of the center of the sphere in 3D space and 1 parameter for a radius r of the sphere.

Performing an intersection test between a bounding shape parameterized by fewer parameters than a first bounding volume and a second bounding volume may involve using less computational resources when compared to performing an intersection test between the two bounding volumes. For example, using the separating axis tests to perform an intersection test between a first OBB bounding volume and a second AABB bounding volume may require up to 81 multiplications to check all 15 possible separating axes between the OBB and AABB. In contrast, performing an intersection test for a spherical bounding shape that contains the first OBB bounding volume and the second AABB bounding volume involves only 3 multiplications.

In some embodiments, block 306 comprises determining bounding shapes for both the first and second bounding volumes. The remainder of this description assumes that a bounding shape is determined for a first object, but the second bounding volume described elsewhere herein (e.g. in the block 308 bounding shape intersection test) may itself be a bounding shape determined in block 306.

After determining the bounding shape in step 306, method 300 proceeds to step 308 which performs a bounding shape intersection test for the first and second bounding volumes. The bounding shape intersection test checks whether the step 306 bounding shape (which contains one of the bounding volumes) intersects the other bounding volume (e.g. the second bounding volume).

FIG. 3B is a schematic diagram showing a cross-sectional view of a bounding shape intersection test 400B according to a non-limiting example embodiment.

In FIG. 3B, first bounding volume 402 is shown in a pose 402-1. A bounding shape 406 has been chosen for first bounding volume 402 such that bounding shape 406 contains first bounding volume 402. In FIG. 3B, bounding shape 406 is shown as a sphere for illustrative purpose only. Bounding shape 406 may be any suitable shape. For example, bounding shape 306 may be ellipsoidal in shape.

In FIG. 3B, bounding shape 406 does not intersect second bounding volume 404 when first bounding volume 402 is in pose 402-1. The lack of intersection between bounding shape 406 and second bounding volume 404 leads to the conclusion that there is no intersection between first and second bounding volumes 402, 404 because bounding shape 406 contains first bounding volume 402 so it would be impossible for second bounding volume 404 to intersect with first bounding volume 402 without also intersecting bounding shape 406.

Returning to FIG. 3A, if it is determined at step 308 that there is no intersection between the bounding shape (e.g. bounding shape 406) and the other bounding volume (e.g. second bounding volume 404), then method 300 proceeds to step 310 which concludes that there is no collision between the first and second objects (which are respectively represented by the first and second bounding volumes (e.g. first and second bounding volumes 402, 404) . . .

On the other hand, if there is an intersection between the bounding shape (e.g. bounding shape 406) and the second bounding volume (e.g. second bounding volume 404) at step 308, then it is inconclusive whether the first and second objects would collide. FIG. 3C is a schematic diagram showing a cross-sectional view of a bounding shape intersection test 400C according to another example embodiment. FIG. 3D is a schematic diagram showing a cross-sectional view of a bounding shape intersection test 400D according to another example embodiment. In FIGS. 3C and 3D, bounding shape 406 is a sphere, but this is not necessary and bounding shape 406 may be any suitable shape.

In FIG. 3C, first bounding volume 402 is in a pose 402-2. Bounding shape 406 intersects second bounding volume 404 in intersection test 400C. However, as can be seen from FIG. 3C, first bounding volume 402 does not intersect second bounding volume 404 in pose 402-2. In FIG. 2D, first bounding volume 402 is in a pose 402-3. Bounding shape 406 intersects second bounding volume 404 in intersection test 400D. First bounding volume 402 also intersects second bounding volume 404 in pose 402-3. FIGS. 3C and 3D illustrate that if there is an intersection between bounding shape 406 and second bounding volume 404 in the block 306 bounding shape intersection test, then it is not possible to draw definitive conclusions about collisions between first and second bounding volumes 402, 404. Therefore, returning to FIG. 3A, in the case of the bounding shape (e.g. bounding shape 406) intersecting with the second bounding volume (e.g. second bounding volume 404), method 300 proceeds to step 312 to perform further collision testing because it is inconclusive whether the first and second objects would collide based on the step 306 bounding shape intersection test.

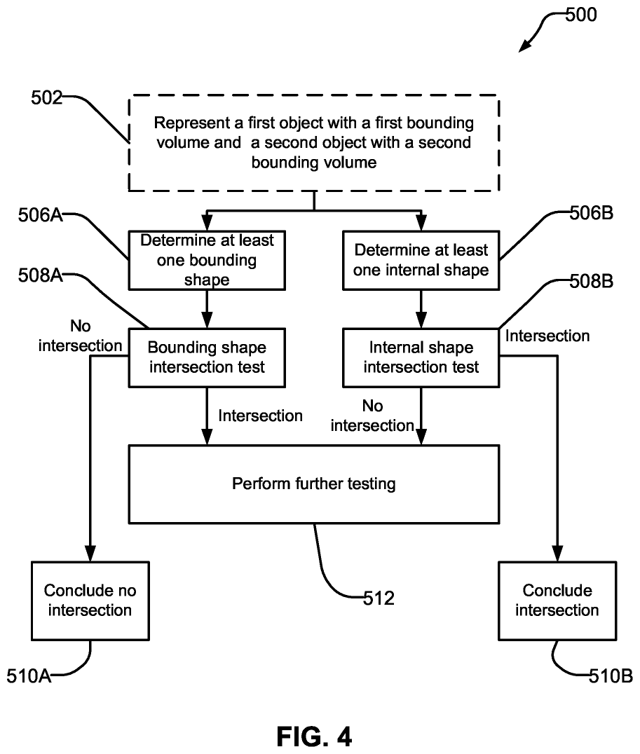

FIG. 4 is a flowchart of a method 500 for evaluating whether there is a collision between a first object and a second object according to another example embodiment.

Similar to methods 100 and 300, method 500 begins with the optional step 502 of representing a first object with a first bounding volume and representing a second object with a second bounding volume. The first and second bounding volumes respectively contain the first and second objects. The description of steps 102, 104 of method 100 and steps of 302, 304 of method 300 similarly applies to step 502 of method 500 and for the sake of brevity will not be repeated here.

Method 500 then proceeds to step 506A of determining a bounding shape and step 506B of determining at least one internal shape for a corresponding one (e.g. a first one) of the two bounding volumes. Step 506A is similar to step 306 and step 506B is similar to step 106 and for the sake of brevity will not be repeated here.

Method 500 then proceeds to step 508A which involves performing a bounding shape intersection test and step 508B which involves performing an internal shape intersection test. Step 508A is similar to step 308 of method 300 and step 508B is similar to step 108 of method 100 and for the sake of brevity will not be repeated here. In some embodiments, steps 508A, 508B are performed in parallel using a parallel processing technique. The parallel processing technique may be any suitable parallel processing technique and ay involve the use of suitably configured hardware.

In some embodiments, step 508A is performed and completed prior to initiating step 508B. In some embodiments, step 508B is performed and completed prior to initiating step 508A.

If the step 508A bounding shape intersection test determines that there is no intersection between the bounding shape and the second bounding volume, then method 500 proceeds to step 510A to conclude that there is no collision between the first and second objects. If the step 508B internal shape intersection test determines that there is an intersection between the internal shape and the second bounding volume, then method 500 proceeds to step 510B to conclude that there is a collision between the first and second objects.

In the event that the step 508A bounding shape intersection test determines that there is an intersection between the bounding shape and the second bounding volume and that the step 50B internal shape intersection tests determines that there is no intersection between the internal shape and the second bounding volume, then method 500 proceeds to step 512 which determines that it is inconclusive whether there is a collision between the first and second objects and requires further collision testing to determine whether the first and second objects would collide because the results of both the step 508A bounding shape intersection test and the step 508B internal shape intersection test are inconclusive.

The outcome of method 500 for any given pose can be summarized by the following logic table:

TABLE 1
Logic Table of Method 500

| | | Bounding Shape Intersection Test | |
|---|---|---|---|
| Method 500 Logic Table | | Intersection | No Intersection |
| Internal | Intersection | Collision; End Test | Impossible Result |
| Shape | No | Inconclusive; | No Collision; |
| Intersection | Intersection | Further Tests | End Test |
| Test | | | |

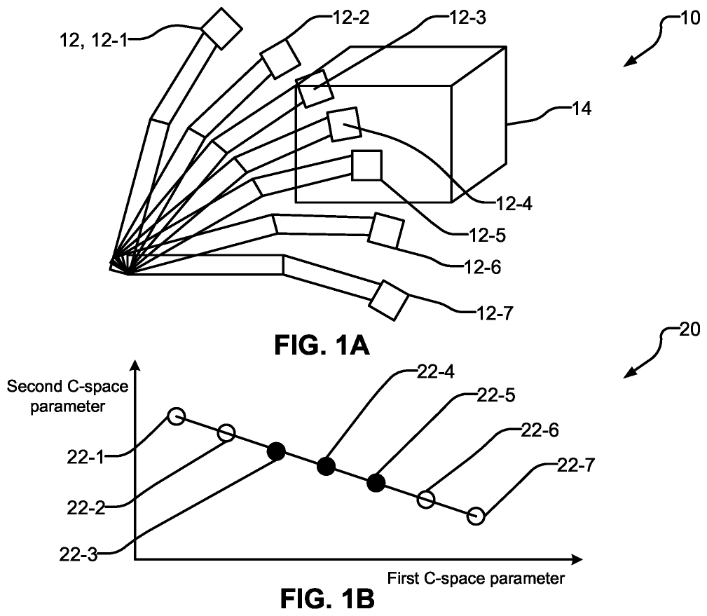

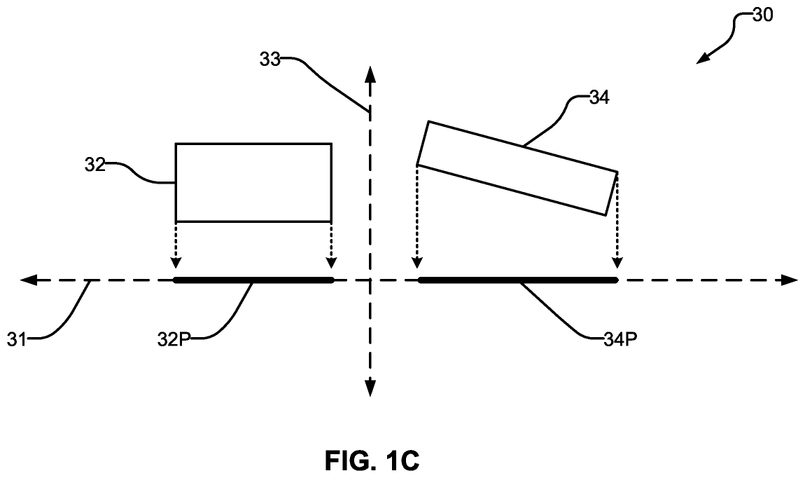

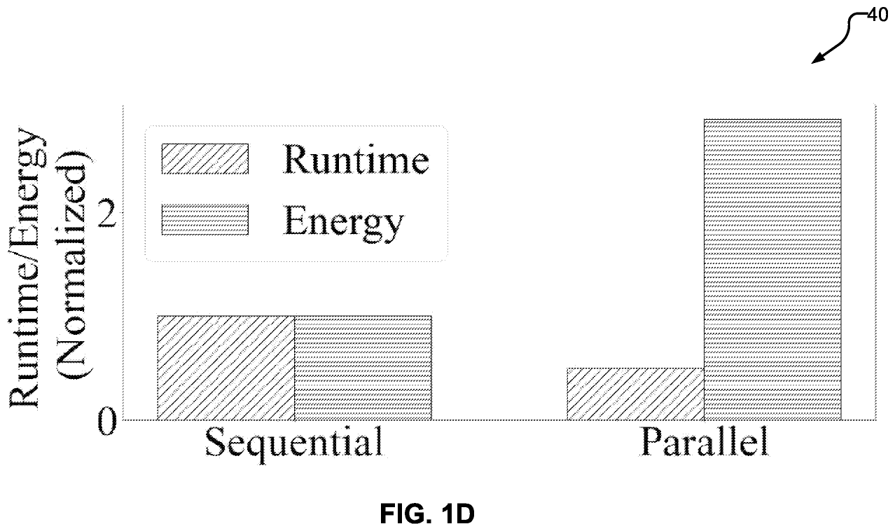

Methods 100, 300 and 500 described herein may be applied to collision detection tests in motion planning tasks. For example, methods 100, 300 and 500 may be applied to poses in a potential motion trajectory (e.g. poses 12-1 to 12-7 of example motion trajectory 10 shown in FIG. 1A) to evaluate whether there is collision between a first object (e.g. robotic arm 12) and a second object (e.g. obstacle 14) in the potential motion trajectory.

In some embodiments, methods 100, 300 and 500 are applied in conjunction with other intersection tests (e.g. separating axis tests or other suitable intersection tests) to evaluate whether there is a collision between a first object and a second object, for example, for a plurality of poses in a planned motion trajectory.

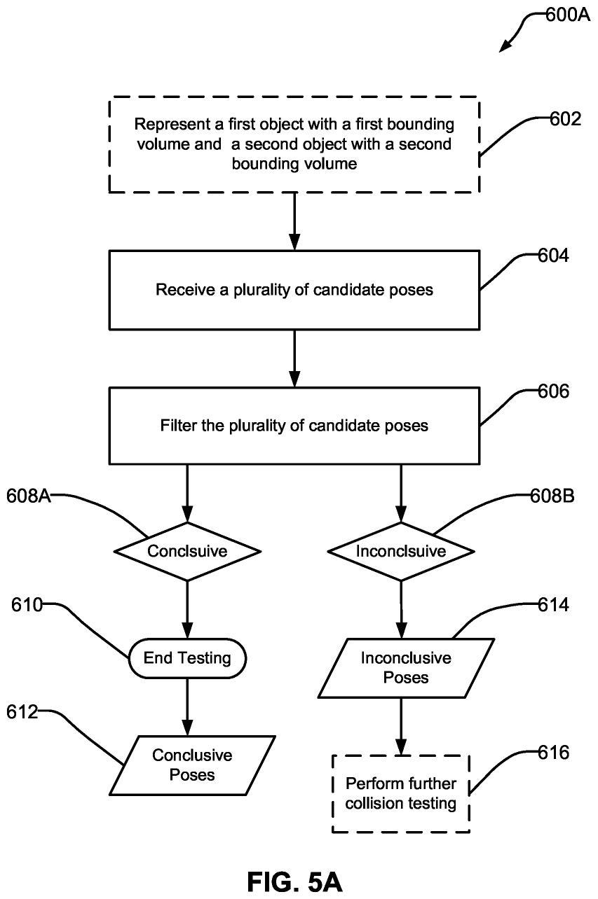

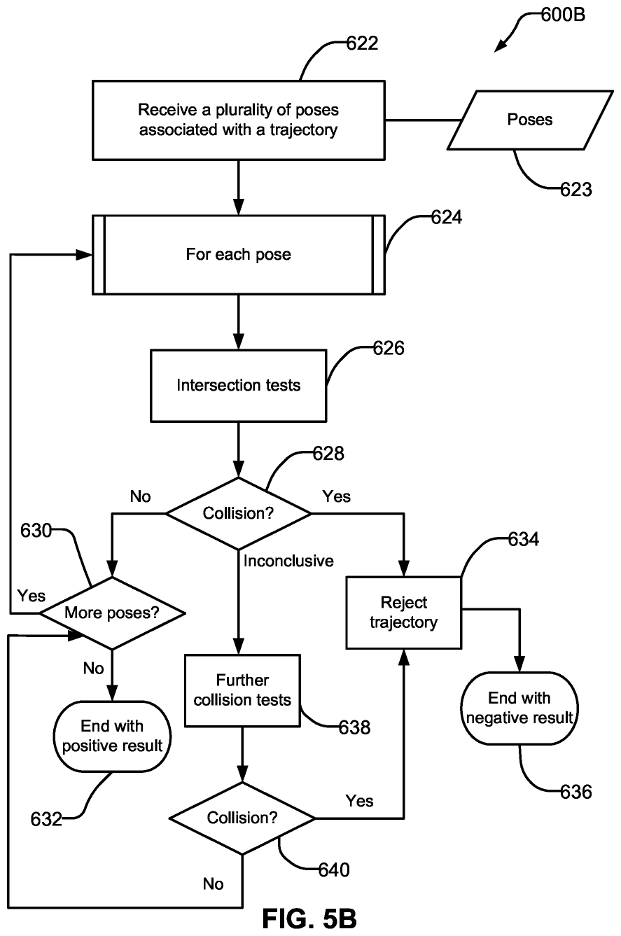

FIG. 5A is a flowchart of a method 600A for filtering a plurality of candidate poses between a first object and a second object according to an example embodiment. Method 600A may be applied, for example, to a plurality of randomly generated poses to identify poses that result in collision and poses that do not result in collision. A motion trajectory may consequently be based at least in part on the poses filtered by method 600A that do not result in a collision. Method 600A may also be applied to a plurality of poses in a motion trajectory.

Method 600A may begin with the optional step 602 of representing the first object with a first bounding volume and the second object with a second bounding volume. In some embodiments, step 602 may be skipped if the first and second objects are already represented by respective first and second bounding volumes.

At step 604, method 600A receives or otherwise obtains or generates a plurality of candidate poses between the first bounding volume (which represents the first object) and the second bounding volume (which represents the second object). Each pose may specify (using any suitable representation), the location and orientation of the first and second bounding volumes. In some embodiments, the plurality of candidate poses comprises at least one randomly generated pose. In some embodiments, the plurality of candidate poses comprises a combination of randomly generated poses and proposed poses from a motion trajectory. In some embodiments, the plurality of candidate poses comprises randomly generated poses. In some embodiments, the plurality of candidate poses comprises a number of poses on a proposed motion trajectory.

At step 606, method 600A filters the plurality of candidate poses by applying internal shape intersection test and/or bounding shape intersection test to each candidate pose. For a given candidate pose, if method 600A determines a conclusive result 608A (i.e. intersection or no intersection), then method 600A proceeds to step 610 to end the intersection test and eliminate the given candidate pose from further testing by categorizing the candidate pose as either intersecting (collision) or not intersecting (no collision). On the other hand, for a given candidate pose, if method 600A determines that the result from step 606 is inconclusive 608B, then the given candidate pose is categorized as an inconclusive pose and method 600A may optionally proceed to step 616 to perform further collision testing for the inconclusive poses. In some embodiments, step 616 is omitted to avoid incurring further computational expense.

FIG. 5B is a flowchart showing a logical structure of a method 600B for detecting collisions in poses of a motion trajectory according to an example embodiment. It is to be understood that FIG. 5B presents the logic of method 600B and does not limit the execution sequence of method 600B. For example, the processing of method 600B or at least portions of method 600B may be parallelized in any suitable manner. Method 600B may be applied, for example, to a motion trajectory (e.g. motion trajectory 10) to evaluate whether the first and second objects would collide over the course of the motion trajectory.

Method 600B begins with step 622 of receiving or otherwise obtaining a plurality of poses 623 associated with a trajectory. Method 600B then enters a sub-routine 624 which may be performed for each pose or until a proposed motion trajectory is evaluated to be negative because of a collision.

Sub-routine 624 begins with step 626 of applying intersection tests to the pose. In some embodiments, intersection tests performed at step 626 comprise internal shape intersection test, or bounding shape intersection test, or a combination thereof. For example, bounding shape intersection test can be applied to evaluate whether a conclusion of no collision can be drawn and internal shape intersection test can be applied to evaluate whether a conclusion of collision can be drawn. In some embodiments, intersection tests performed at step 626 comprise other suitable intersection tests.

After performing intersection tests at step 626, sub-routine 624 arrives at a first decision juncture 628 which determines which subsequent logical route of sub-routine 624 should be followed. At first decision juncture 628, there are three possible outcomes, and therefore, three possible subsequent routes to follow: (1) no collision; (2) collision; (3) inconclusive.

If a conclusion of no collision has been reached at decision juncture 628 after performing intersection tests at step 626, then sub-routine 624 proceeds down the “No” branch of decision juncture 628, to arrive at a second decision juncture 630, which evaluates whether there are more poses to be evaluated among the plurality of poses 623. If there are more poses to be evaluated, then sub-routine 624 proceeds down the “Yes” branch of decision juncture 630 and loops back to step 624 which enters another iteration of sub-routine 624 for another pose. If there is no pose remaining to be evaluated at decision juncture 630, then sub-routine 624 proceeds down the “No” branch of decision juncture 630 and arrives at end step 632, which ends the evaluation of the trajectory with a positive result (i.e. no collision in the trajectory).

Returning to decision juncture 628, if a conclusion of collision has been reached at decision juncture 628, then sub-routine 624 proceeds down the “Yes” branch of decision juncture 628, to arrive at step 634 rejecting the trajectory because a collision has been determined for the trajectory. Sub-routine 624 then proceeds to end step 636 which ends the evaluation of the trajectory with a negative result (i.e. collision in the trajectory).

Returning again to decision juncture 628, if the result of intersection tests at step 626 is inconclusive, then sub-routine 624 proceeds down the “Inconclusive” branch of decision juncture 628, which arrives at step 638 of performing further collision testing on the given pose. After the application of further collision testing at step 638, sub-routine 624 arrives at a third decision juncture 640. At third decision juncture 640, there are two possible outcomes, and therefore, two possible subsequent routes to follow: (1) no collision; and (2) collision. If a conclusion of collision has been reached, then sub-routine 624 proceeds down the “Yes” branch of decision juncture 640 and arrives at step 634 of rejecting the trajectory and then proceeds to end step 636 to end the evaluation of the trajectory with a negative result (i.e. collision in the trajectory). If a conclusion of no collision has been reached, then sub-routine 624 proceeds down the “No” branch of decision juncture 640 and arrives at second decision juncture 630 which evaluates whether there are more poses to be evaluated among the plurality of poses 623. If there are more poses to be evaluated, then sub-routine 624 loops back to iterate over the next pose for evaluation. If there is no more pose to be evaluated, then sub-routine 624 proceeds to end step 632 which ends the evaluation of the trajectory with a positive result (i.e. no collision in the trajectory).

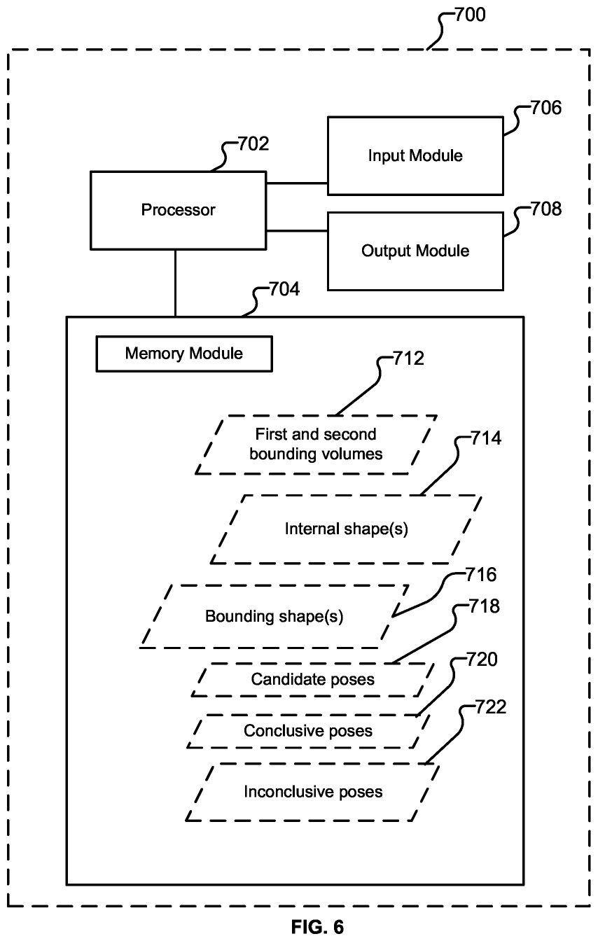

Some aspects of the invention provide a computing system 700 (an example embodiment of which is shown in FIG. 6) or any similarly configured systems or processor(s) for performing one or more of the methods described herein (e.g. the methods 100, 300, 500 and 600A, 600B of FIGS. 2A, 3A, 4 and 5 or portions thereof). System 700 may comprise a processor 702, a memory module 704, an input module 706, and an output module 708. System 700 may be any suitable general purpose computer/processor. Memory module 704 may store one or more of the bounding volumes 712, internal shape(s) 714, bounding shape(s) 716, candidate poses 718, conclusive poses 720 and/or inconclusive poses 722 described herein. Processor 702 may receive (via input module 706) first and second bounding volumes 712 of first and second objects and internal shape(s) 714 and/or bounding shape 716 and may store these inputs in memory module 704. Processor 702 may perform methods 100, 300 or 500 to perform internal shape intersection test and/or bounding shape intersection test as described herein, and store the conclusions 720, 722 in memory module 704. Processor 702 may perform method(s) 600A, 600B described herein. Processor 702 may receive a plurality of candidate poses 718 as input to filter the plurality of candidate poses 718 for example in accordance with methods 600A, 600B and may store the conclusive and inconclusive poses 720, 722 in memory module 704.

The methods described herein have the advantages of reducing computational expense in collision detection computation compared to known intersection tests, such as the separating axis test. As described elsewhere herein, in a non-limiting example embodiment of a pair of cuboid OBB-AABB bounding boxes, if either an internal shape or a bounding shape is determined for the OBB, then the internal shape intersection test or the bounding shape intersection test requires only three multiplications to be performed, compared to up to 81 multiplications that may be required to check all 15 possible separating axes for the pair of cuboid OBB-ABB bounding boxes.

In some embodiments, the methods described herein are applied to filter collision detection cases (e.g. poses) to eliminate a first plurality of cases from further testing because a conclusion can be drawn for each of the first plurality of cases with the application of methods 100, 300 and 500 prior to conducting other intersection tests. Further intersection tests only need to be applied to a second plurality of cases. The second plurality of cases are cases that remain after the first plurality of cases have already been filtered (i.e. eliminated from further testing) after the application of methods 100, 300 and 500.

It has been evaluated from experimental testing that internal shape intersection test (i.e. step 508B of method 500 shown in FIG. 4) can reduce computation for collision tests by about 66% for robot-environment collision tests during motion planning. The amount of computation is approximated using the number of multiplications performed.

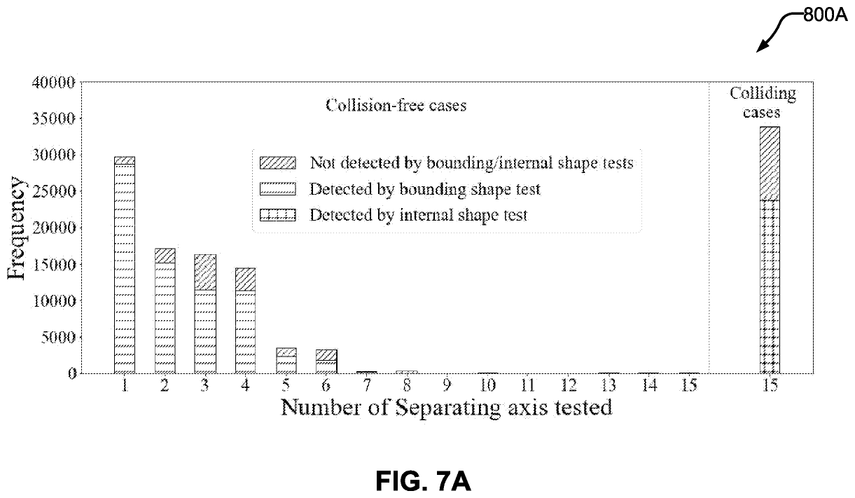

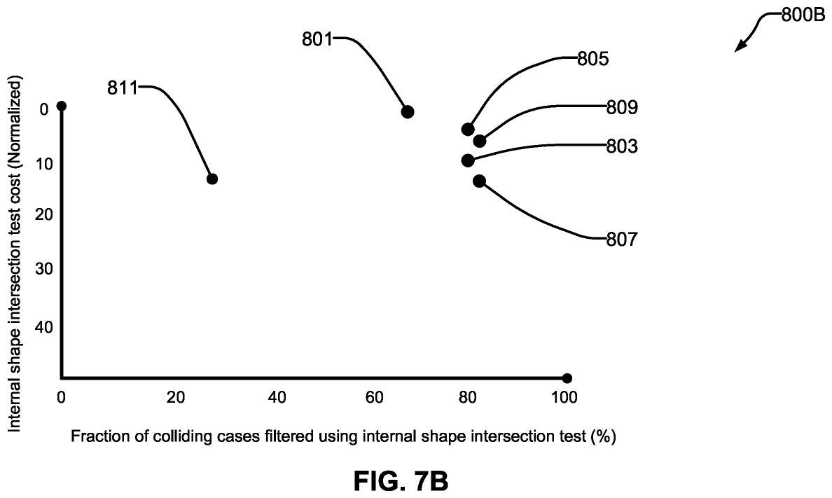

FIG. 7A is a bar chart 800A showing experimental data on the efficacy of internal shape intersection test and bounding shape intersection test. Bar chart 800A plots the frequency of number of attempts needed to identify a first valid separating axis (i.e. a collision free result) for a large number of separating axis tests run for different poses between cuboid OBB and AABB bounding boxes. The horizontal axis of plot 800A indicates the number of separating axes that needed to be tested to identify a separating axis and thereby reach a collision free conclusion. The vertical axis of plot 800A indicates the number of cases (i.e. poses) from the experimental data where the collision free result was determined for each separating axis. The shading of the vertical bars identified how the collision free conclusion was determined. Specifically, the cases that where a collision free result is determined by the bounding shape intersection test described herein are shown with horizontal shading and the cases where the separating axis test was required to reach the collision free result are shown with angular shading. For example, in the case of the first separating axis, a “not in collision” result was determined for 29758 cases and, of those cases, 28763 cases were determined by the bounding shape intersection test and 995 cases were not determined by the bounding shape intersection test; and in the case of the second separating axis, a “not in collision” result was determined for 17146 cases and, of those cases, 15177 were determined by the bounding shape intersection test and 1969 cases were not determined by the bounding shape intersection test.

The FIG. 7A chart 800A also presents, in the rightmost bar, experimental data relating to colliding cases, where the vertical and horizontal shading represents the number of cases that were determined to be colliding by the internal shape intersection test and the angular shading represents the number of cases that were determined to be colliding by evaluating all 15 separating axes. It will be appreciated that 15 separating axes have to be evaluated to conclude that there does not exist a separating axis and there is a collision. The experimental data for the colliding cases involved 33812 cases of which 23730 were determined to be colliding by the internal shape intersection test and 10082 were not determined by the internal shape intersection test.

The plot 800A experimental data shows the efficacy of applying the bounding shape intersection test and the internal shape intersection test to first filter the cases (i.e. poses), then the number of remaining cases to be checked by other intersection tests (e.g. separating axis tests) is significantly lower when compared to only using the separating axis test. As discussed above, the bounding shape intersection test and the internal shape intersection test are computationally less intensive than a standard separating axis test. Accordingly, applying an internal shape intersection test and/or a bounding shape intersection test may have the advantage of reducing computational expense in collision detection tests in motion planning tasks relative to using conventional collision detection tests (such as the separating axis test).

In summary, the bounding shape intersection test and/or internal shape intersection test can reduce overall computational expense of collision detection in motion planning by:
detecting (e.g. filtering) a large number of cases of definite collision or no collision with much lower computational expense compared to drawing similar collision or no collision conclusions about those cases using conventional collision detection (e.g. separating axis) techniques; and,
significantly reducing the number of cases that need to be evaluated by computationally more intensive tests (e.g. standard separating axis tests).

The inventors conducted an experiment to study the efficiencies and filtering percentage of various configurations of internal shape intersection tests. For the experiment, the first bounding volume was an OBB and the second bounding volume was an AABB. The experiment was conducted with 3D shapes. The various configurations of the internal shape intersection test are shown in Table 2 below.

TABLE 2
Description of different internal shapes and corresponding
intersection test configurations

| | Internal shape | Internal shape | Type of |
|---|---|---|---|
| Configuration | for first | for the second | Internal Shape |
| (shown in | bounding volume | bounding volume | Intersection |
| FIG. 7B) | (e.g. OBB) | (e.g. AABB) | test |
| 801 | Centered Sphere | — | Sphere-AABB |
| 803 | Two spheres | — | Two |
| | | | sphere-AABB |
| | | | (parallel |
| | | | execution |
| | | | of both tests) |
| 805 | Two spheres | — | Two |
| | | | sphere-AABB |
| | | | (serial |
| | | | execution |
| | | | of both tests) |
| 807 | Three spheres | — | Three |
| | | | sphere-AABB |
| | | | (parallel |
| | | | execution |
| | | | of all tests) |
| 809 | Three spheres | — | Three |
| | | | sphere-AABB |
| | | | (serial |
| | | | execution |
| | | | of all tests) |
| 811 | Ellipsoid | Sphere | Ellipsoid-sphere |

FIG. 7B is a plot 800B showing the cost of each of the above configurations shown in Table 2 versus the percentage of cases filtered by each of the configurations.

As can be seen in plot 800B, single centered sphere configuration 801, which is the single centered sphere-AABB configuration such as those shown in FIGS. 2B-D, has the lowest added cost while filtering about 70% of the cases. Configurations 803 and 805 are both two sphere-AABB tests (e.g. as shown in FIG. 2E) with configuration 803 being parallel execution and configuration 805 being serial execution. Configuration 803 incurs slightly higher cost while filtering almost the same amount of cases, at about 80%. Configurations 807 and 809 are both three sphere-AABB tests (e.g. as shown in FIG. 2F) with configuration 807 being parallel execution and configuration 809 being serial execution. Similarly, configuration 807 incurs slightly higher cost while filtering almost the same amount of cases, slightly above 80%. The three sphere-AABB configurations 807 and 809 both filter slightly more cases than the two sphere-AABB configurations 803 and 805. Configuration 811, which is the ellipsoid-sphere configuration shown in FIG. 2G, incurs the highest cost among the Table 2 configurations, while filtering the fewest number of cases, at about 30%.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMS, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value+5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for evaluating whether there is a collision between a first object represented by a first bounding volume and a second object represented by a second bounding volume, the method comprising:
determining at least one internal shape, the at least one internal shape contained within the first bounding volume; and,
determining that there is an intersection between the at least one internal shape and the second bounding volume to conclude that there is a collision between the first object and the second object.

2. The method of claim 1 comprising:
determining a bounding shape, wherein the bounding shape contains the first bounding volume;
determining that there is no intersection between the bounding shape and the second bounding volume to conclude that there is no collision between the first object and the second object.

3. The method of claim 1 comprising determining that there is no intersection between the at least one internal shape and the second bounding volume and thereby concluding that further collision testing is required to evaluate whether there is a collision between the first object and the second object.

4. The method of claim 3 comprising, after concluding that further collision testing is required, performing the further collision testing to evaluate whether there is a collision between the first object and the second object.

5. The method of claim 2 comprising determining that there is no intersection between the at least one internal shape and the second bounding volume and that there is an intersection between the bounding shape and the second bounding volume and thereby concluding that further collision testing is required to evaluate whether there is a collision between the first object and the second object.

6. The method of claim 5 comprising, after concluding that further collision testing is required, performing the further collision testing to evaluate whether there is a collision between the first object and the second object.

7. The method of claim 2, wherein determining that there is an intersection between the at least one internal shape and the second bounding volume and determining that there is no intersection between the bounding shape and the second bounding volume are performed using a parallel processing technique.

8. The method of claim 1, wherein the at least one internal shape comprises an inscribed shape.

9. The method of claim 1, wherein the at least one internal shape is the largest sphere that is contained within the first bounding volume.

10. The method of claim 2, wherein the first bounding volume is inscribed within the bounding shape.

11. The method of claim 2, wherein the bounding shape is the smallest sphere that encloses the first bounding volume.

12. The method of claim 1, wherein the at least one internal shape is parameterized by a number n of parameters that is fewer than a number m of parameters used to parameterize the first bounding volume.

13. The method of claim 12, wherein the number m of parameters used to parameterize the first bounding volume is 9.

14. The method of claim 12, wherein the number n of parameters used to parameterize the internal shape is 4.

15. The method of claim 2 wherein the bounding shape is parameterized by a number p of parameters that is fewer than a number of parameters m used to parameterize the first bounding volume.

16. The method of claim 15, wherein the number p of parameters used to parameterize the bounding shape is 4.

17. The method of claim 1, wherein the first bounding volume comprises an oriented bounding box (OBB) and the second volume comprises one of: an OBB and an axis-aligned bounding box (AABB).

18. The method of claim 1, wherein determining that there is an intersection between the at least one internal shape and the second bounding volume requires computing no more than three multiplications.

19. The method of claim 2, wherein determining that there is no intersection between the bounding shape and the second bounding volume requires computing no more than three multiplications.

20. The method according to claim 1, wherein the at least one internal shape comprises two or more internal shapes.

21. The method according to claim 20, wherein determining that there is an intersection between the at least one internal shape and the second bounding volume comprises determining that there is an intersection between the second bounding volume and at least one of the two or more internal shapes.

22. A method for filtering a plurality of candidate poses between a first object and a second object in a collision detection test between the first object represented by a first bounding volume and the second object represented by a second bounding volume, the method comprising:
determining at least one internal shape, the at least one internal shape contained within the first bounding volume; and
eliminating one or more colliding poses from the plurality of candidate poses by, for each colliding pose, determining that there is an intersection between the at least one internal shape and the second bounding volume to conclude that there is a collision between the first object and the second object.

23. The method of claim 22 comprising:
determining a bounding shape, wherein the bounding shape contains the first bounding volume; and
eliminating one or more non-colliding poses from the plurality of candidate poses by, for each non-colliding pose, determining that there is no intersection between the bounding shape and the second bounding volume to conclude that there is no collision between the first object and the second object.

24. The method of claim 23 comprising:
performing further collision testing for non-eliminated candidate poses.

25. The method of claim 23 wherein the plurality of candidate poses comprises a plurality of poses in a proposed motion trajectory or a plurality of randomly generated poses for at least one of the first and second objects.
